(19) United States
(12) Patent Application Publication
(10) Pub. No.: US 2026/0152196 A1
(43) Pub. Date: Jun. 4, 2026

(54) METHOD AND SYSTEM FOR NOTIFICATION AND FACILITATION OF MULTIPLE CHOICES OF FORTHCOMING ACTION FOR ASSISTED DRIVING

(71) Applicant: GM Global Technology Operations LLC, Detroit, MI (US)

(72) Inventor: Yuan Zhang, Pudong (CN)

(21) Appl. No.: 19/033,795

(22) Filed: Jan. 22, 2025

(30) Foreign Application Priority Data
Dec. 4, 2024 (CN) 202411773383.6

(51) Int. Cl. B60W 50/08; B60W 30/02

(52) U.S. Cl. CPC B60W 50/085; B60W 30/025; B60W 2554/408; B60W 2556/45

(57) ABSTRACT

A method of presenting multiple choices to a host vehicle operator during automated driving of a host vehicle and system is provided. The method includes receiving information at least partially based on a host vehicle environment and determining multiple first actions when the host vehicle is at a distance to estimate a location of advantage-gaining actions. The multiple first actions include at least a first choice and a second choice. The method also includes presenting the multiple first actions to the vehicle operator, receiving an input from the vehicle operator, and determining a second action based on the input from the vehicle operator. The second action includes at least one of providing no further system assistance to the host vehicle operator, providing the host vehicle operator with system assistance corresponding to the first choice, or providing the host vehicle operator with system assistance corresponding to the second choice.

### INTRODUCTION

The present disclosure relates to systems and methods for providing information to an operator of a vehicle.

To increase occupant awareness and convenience, vehicles may be equipped with advanced driver assistance systems (ADAS) and/or automated driving systems (ADS). ADAS systems may use various sensors such as cameras, radar, and LiDAR (light detection and ranging) to detect and identify objects around the vehicle, including other vehicles, pedestrians, road configurations, traffic signs, and road markings. ADAS systems may take actions based on environmental conditions surrounding the vehicle, such as applying brakes or alerting an occupant of the vehicle. ADS systems may use various sensors to detect objects in the environment around the vehicle and control the vehicle to navigate the vehicle through the environment to a predetermined destination. However, current ADAS and ADS systems may not effectively facilitate green passing and/or smooth driving when an objective-achieving system action is deemed too aggressive and causes surprise to a vehicle operator.

Thus, while ADAS and ADS systems and methods achieve their intended purpose, there is a need for a new and improved system and method for avoiding driver surprise and facilitating user interactions for advantage-gaining actions.

### SUMMARY

According to several aspects of the present disclosure, a method of presenting multiple choices to a host vehicle operator to maintain smooth driving during automated or driver assisted driving of a host vehicle is provided. The method includes receiving information at least partially based on a host vehicle environment and determining multiple first actions based on the information when the host vehicle is at a distance to estimate a location of advantage-gaining actions. The multiple first actions include at least a first choice and a second choice. The method also includes presenting the multiple first actions to the host vehicle operator, receiving an input from the host vehicle operator based on the multiple first actions, and determining a second action based on the input from the host vehicle operator. The second action includes at least one of providing no further system assistance to the host vehicle operator, providing the host vehicle operator with system assistance corresponding to the first choice, or providing the host vehicle operator with system assistance corresponding to the second choice.

In accordance with another aspect of the disclosure, the host vehicle environment includes at least one of surrounding traffic patterns or host vehicle turning options.

In accordance with another aspect of the disclosure, the information includes at least one of V2X messages related to key impacting traffic participants, traffic light signals, traffic patterns, onboard perception data, host vehicle route planning, a host vehicle recent speed profile, or a host vehicle operator preference model.

In accordance with another aspect of the disclosure, determining the first choice and the second choice includes determining multiple host vehicle maneuvering choices.

In accordance with another aspect of the disclosure, determining multiple first actions includes determining a third choice.

In accordance with another aspect of the disclosure, presenting the multiple first actions to the host vehicle operator includes presenting a first choice that gains a higher advantage than the second choice and a second choice having a higher probability of success than the first choice.

In accordance with another aspect of the disclosure, presenting the multiple first actions to the host vehicle operator includes presenting a preview stage having suggestions to the host vehicle operator including at least one of an estimated location, an action type, a feasible spatial and temporal range, an expected challenge, or dominant impacts per-lane.

In accordance with another aspect of the disclosure, presenting includes refreshing re-determined first choice and second choice actions until an input is received from the host vehicle operator.

In accordance with another aspect of the disclosure, presenting the multiple first actions to the host vehicle operator includes presenting a notification of the multiple first actions to a human-machine interface (HMI).

In accordance with another aspect of the disclosure, receiving the input includes at least one of receiving an indication that the host vehicle operator at least one of dismissed all the multiple first actions, dismissed one of the multiple first actions, switched an order of the multiple first actions, or entered no input.

In accordance with another aspect of the disclosure, the method further comprises using learning-based optimization based on receiving the input from the host vehicle operator.

In accordance with another aspect of the disclosure, the method further comprises providing system assistance by driving the host vehicle based on the input from the host vehicle operator.

According to several aspects of the present disclosure, a system for presenting multiple choices to a host vehicle operator to maintain smooth driving during automated or driver assisted driving of a host vehicle is provided. The system includes a vehicle communication system, a display, and a controller in electrical communication with the vehicle communication system and the display. The controller is programmed to receive information at least partially based on a host vehicle environment and to determine multiple first actions based on the information when the host vehicle is at a distance to estimate a location of advantage-gaining actions. The multiple first actions include at least a first choice and a second choice. The controller is also programmed to present the multiple first actions to the host vehicle operator, to receive an input from the host vehicle operator based on the multiple first actions, and to determine a second action based on the input from the host vehicle operator. The second action includes at least one of providing no further system assistance to the host vehicle operator, providing the host vehicle operator with system assistance corresponding to the first choice, or providing the host vehicle operator with system assistance corresponding to the second choice.

In accordance with another aspect of the disclosure, the host vehicle environment includes at least one of surrounding traffic patterns or host vehicle turning options.

In accordance with another aspect of the disclosure, the information includes at least one of V2X messages related to key impacting traffic participants, traffic light signals, traffic patterns, onboard perception data, host vehicle route planning, a host vehicle recent speed profile, or a host vehicle operator preference model.

In accordance with another aspect of the disclosure, determining the first choice and the second choice includes determining multiple host vehicle maneuvering choices.

In accordance with another aspect of the disclosure, presenting the multiple first actions to the host vehicle operator includes presenting a first choice that gains a higher advantage and a second choice having a higher probability of success.

In accordance with another aspect of the disclosure, the presenting step includes refreshing re-determined first choice and second choice actions until an input is received from the host vehicle operator.

In accordance with another aspect of the disclosure, receiving the input includes at least one of receiving an indication that the host vehicle operator at least one of dismissed all the multiple first actions, dismissed one of the multiple first actions, switched an order of the multiple first actions, or entered no input.

According to several aspects of the present disclosure, a method of presenting multiple choices to a host vehicle operator to maintain smooth driving during automated or driver assisted driving of a host vehicle is provided. The method includes receiving information at least partially based on a host vehicle environment and determining multiple first actions based on the information when the host vehicle is at a distance to estimate a location of advantage-gaining actions. The multiple first actions include at least a first choice and a second choice. The method also includes presenting the multiple first actions to the host vehicle operator and receiving an input from the host vehicle operator based on the multiple first actions including at least one of receiving an indication that the host vehicle operator at least one of dismissed all the multiple first actions, dismissed one of the multiple first actions, switched an order of the multiple first actions, or entered no input. The method also includes determining a second action based on the input from the host vehicle operator. The second action includes at least one of providing no further system assistance to the host vehicle operator, providing the host vehicle operator with system assistance corresponding to the first choice, or providing the host vehicle operator with system assistance corresponding to the second choice. Moreover, the method includes providing system assistance by driving the host vehicle based on the input from the host vehicle operator.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for presenting multiple choices to a host vehicle operator to maintain smooth driving during automated or driver assisted driving, in accordance with the present disclosure.

FIG. 2 is a flowchart of a method for presenting multiple choices to a host vehicle operator to maintain smooth driving during automated or driver assisted driving, in accordance with the present disclosure.

FIG. 3 is an exemplary view from an interior of the vehicle showing an exemplary HMI notification, in accordance with the present disclosure.

FIG. 4 illustrates a schematic environmental view of an example scenario of using the method for presenting multiple choices to a host vehicle operator to maintain smooth driving during automated or driver assisted driving, in accordance with the present disclosure.

FIG. 5 illustrates a schematic environmental view of an example scenario of using the method for presenting multiple choices to a host vehicle operator to maintain smooth driving during automated or driver assisted driving, in accordance with the present disclosure.

FIG. 6 illustrates a schematic environmental view of an example scenario of using the method for presenting multiple choices to a host vehicle operator to maintain smooth driving during automated or driver assisted driving, in accordance with the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Despite a driver often being aware of a system's key objective of facilitating green passing (i.e., passing without a full stop) and/or smooth driving, it is desirable to avoid causing surprise to the driver due to an objective-achieving action being deemed too aggressive or without worthwhile motivation. It is also desirable to avoid surprises to the driver by the system and to facilitate subjectively needed interaction to better conform with the driver's preference and promote trust toward the system. Therefore, the present disclosure provides a new and improved system and method for avoiding surprise to the driver and for facilitating driver interaction and advantage-gaining actions while ensuring the driver's satisfaction. The method and system disclosed herein are intended to provide and assist with smooth driving and/or green passing toward some intermediate distance, typically a remaining distance until the traffic light or checkpoint ahead rather than targeted for several intersections ahead or the destination. The interaction options are designed, subject to the driver's comfort and preparedness, to utilize the driver's observation of the nearby driving environment, accommodate the driver's hunch about the satisfactory advantage-gaining action, and to apply learning-based optimization on a driver preference model for improved satisfaction.

Intended for green passing and/or smooth driving, the system gives the driver multiple (typically two, but sometimes three or more) choices of forthcoming advantage-gaining actions (to be performed by the system/controller and/or the driver), such that the first choice (e.g., default) action will gain higher advantage while the second choice (e.g., favorable alternative) action will have a higher probability of success (or the other way around depending on the surrounding traffic, driver preference etc.), and the driver can make or remake the choice within a certain temporal and/or feasible spatial range until entering a finalizing stage (i.e., this range has been passed or at least one choice has been dismissed by the driver).

Additionally, to precisely accommodate the driver's own judgement into the forthcoming action as well as to support learning-based optimization of the solution, the system/controller disclosed herein (during an interaction stage) accepts the driver making or remaking the choice with dismissing both choices (when the driver feels ready to maneuver or take over control with their own judgement), dismisses one choice (when the driver feels confident enough to follow/accept the remaining choice), or switches the choices. In some instances, there is no input (under selected scenarios/situations, if the driver feels comfortable to prioritize on one choice but keep both choices available during some range).

To facilitate the driver's comfortable choice without surprise, the interaction stage is preceded by a preview stage to provide the driver with helpful information, which will be reduced and/or cleared in the interaction stage. For example, the driver may be provided with an estimated location, action types, other informative attributes (e.g. feasible spatial and/or temporal range, expected challenge) of the choices of action, and/or dominant impacts per-lane appearing to the host vehicle (“HV”) (on green passing or smooth driving).

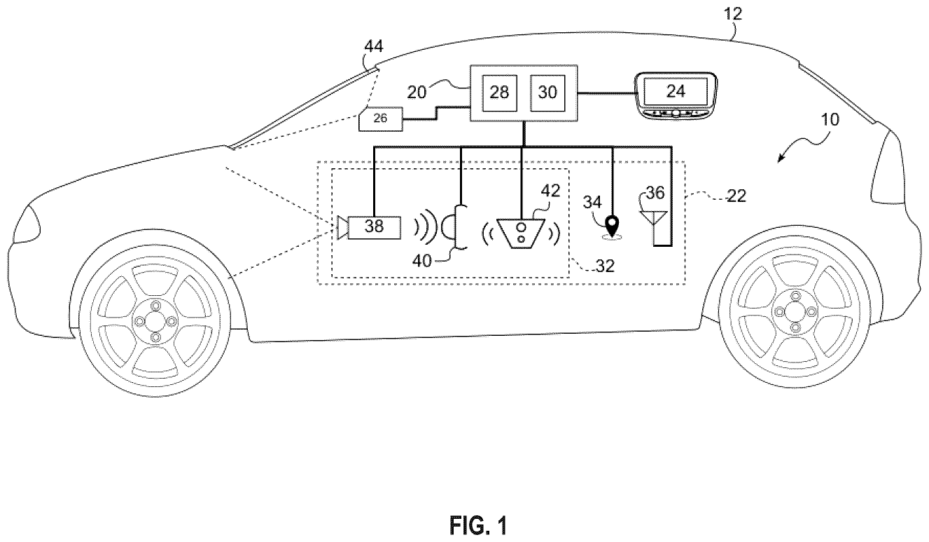

Referring to FIG. 1, a schematic diagram of a system 10 for providing information to an occupant of a vehicle is provided. The system 10 is shown with the host vehicle 12. While a passenger vehicle is illustrated, it should be appreciated that the host vehicle 12 may be any type of vehicle without departing from the scope of the present disclosure. The system 10 generally includes a controller 20, a plurality of vehicle sensors 22, a human-machine interface (HMI) 24, and a head-up display (HUD) 26.

The controller 20 is used to implement a method 100 for providing information to an occupant of a vehicle, as will be described below. The controller 20 includes at least one processor 28 and a non-transitory computer readable storage device or media 30. The processor 28 may be a custom made or commercially available processor, a central processing unit (CPU), a graphics processing unit (GPU), an auxiliary processor among several processors associated with the controller 20, a semiconductor-based microprocessor (in the form of a microchip or chip set), a macroprocessor, a combination thereof, or generally a device for executing instructions.

The computer readable storage device or media 30 may include volatile and nonvolatile storage in read-only memory (ROM), random-access memory (RAM), and keep-alive memory (KAM), for example. KAM is a persistent or non-volatile memory that may be used to store various operating variables while the processor 28 is powered down. The computer-readable storage device or media 30 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 20 to control various systems of the host vehicle 12.

The controller 20 may also consist of multiple controllers which are in electrical communication with each other. The controller 20 may be inter-connected with additional systems and/or controllers of the host vehicle 12, allowing the controller 20 to access data such as, for example, speed, acceleration, braking, and steering angle of the host vehicle 12.

The controller 20 is in electrical communication with the plurality of vehicle sensors 22, the HMI 24, and the HUD 26. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 20 are within the scope of the present disclosure. It should be understood that one or more of the plurality of vehicle sensors 22, the HMI 24, and the HUD 26 may be integrated with the controller 20 (e.g., on a same circuit board with the controller 20 or otherwise a part of the controller 20) without departing from the scope of the present disclosure. It should further be understood that, in the scope of the present disclosure, electrical communication also includes power and/or energy transfer between electrical devices (e.g., using conducting wires and/or wireless power transmission techniques).

The plurality of vehicle sensors 22 is used to acquire information about the host vehicle and/or one or more remote vehicles. In an exemplary embodiment, the plurality of vehicle sensors 22 includes one or more perception sensors 32, a global navigation satellite system (GNSS) 34, and a vehicle communication system 36.

The one or more perception sensors 32 are used to perceive objects and/or measure distances in the environment surrounding the host vehicle 12. In an exemplary embodiment, the one or more perception sensors 32 includes at least one of a camera 38, a radar sensor 40, and a light detection and ranging (LiDAR) sensor 42.

The camera 38 is a perception sensor used to capture images and/or videos of the environment surrounding the host vehicle 12. In an exemplary embodiment, the camera 38 includes a photo and/or video camera which is positioned to view the environment surrounding the host vehicle 12. In a non-limiting example, the camera 38 includes a camera affixed inside of the host vehicle 12, for example, in a headliner of the host vehicle 12, having a view through a windscreen 44 of the host vehicle 12. In another non-limiting example, the camera 38 includes a camera affixed outside of the host vehicle 12, for example, on a roof of the host vehicle 12 having a view of the environment in front of the host vehicle 12.

In another exemplary embodiment, the camera 38 is a surround view camera system including a plurality of cameras (also known as satellite cameras) arranged to provide a view of the environment adjacent to all sides of the host vehicle 12. In a non-limiting example, the camera 38 includes a front-facing camera (mounted, for example, in a front grille of the host vehicle 12), a rear-facing camera (mounted, for example, on a rear tailgate of the host vehicle 12), and two side-facing cameras (mounted, for example, under each of two side-view mirrors of the host vehicle 12). In another non-limiting example, the camera 38 further includes an additional rear-view camera mounted near a center high mounted stop lamp of the host vehicle 12.

It should be understood that camera systems having additional cameras and/or additional mounting locations are within the scope of the present disclosure. It will be further understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure. The camera 38 is in electrical communication with the controller 20, as discussed above.

The radar sensor 40 is used to detect and measure the distance, speed, and direction of objects (e.g., other vehicles surrounding the host vehicle) by emitting radio waves and analyzing reflections of the radio waves. In an exemplary embodiment, the radar sensor 40 includes a radar transmitter (not shown), a radar antenna (not shown), a radar receiver (not shown), and a radar signal processing unit (not shown). In a non-limiting example, the radar transmitter emits radio frequency (RF) signals using the radar antenna, which travel through space until they encounter an object. The RF signals bounce off the object's surface and return to the radar sensor 40. The radar receiver captures the reflected signals using the radar antenna, and the radar signal processing unit analyzes the time delay, frequency shift, and amplitude of the returned RF signals to determine the distance, speed, and direction of the detected objects. The radar sensor 40 is in electrical communication with the controller 20, as discussed above.

The LiDAR sensor 42 is utilized for remote sensing and environmental mapping by emitting laser pulses and measuring the time it takes for the laser pulses to return to the LiDAR sensor 42 after hitting objects. In an exemplary embodiment, the LiDAR sensor 42 includes a LIDAR laser source (not shown), a LIDAR scanner or mirror (not shown), a LiDAR photodetector (not shown), and a LiDAR time-of-flight measurement system (not shown). In a non-limiting example, the LiDAR laser source emits laser pulses that travel to the target area, and the LiDAR scanner directs these pulses in different directions. The emitted laser pulses interact with objects in the environment and their reflections are captured by the LiDAR photodetector. The LiDAR time-of-flight measurement system calculates the distance to the objects based on the time between emission of the laser pulses by the LiDAR laser source and reception of the reflected laser pulses by the LiDAR photodetector. The LiDAR sensor 42 is in electrical communication with the controller 20, as discussed above.

In an exemplary embodiment, the one or more perception sensors 32 are affixed inside of the host vehicle 12, for example, in a headliner of the host vehicle 12, having a view through the windscreen 44 of the host vehicle 12. In another example, the one or more perception sensors 32 are affixed outside of the host vehicle 12, for example, on a roof of the host vehicle 12, having a view of the environment surrounding the host vehicle 12. It should be understood that various additional types of perception sensors, such as, for example, stereoscopic cameras having distance measurement capabilities, ultrasonic ranging sensors, and time-of-flight sensors are within the scope of the present disclosure. The one or more perception sensors 32 are in electrical communication with the controller 20 as discussed above.

The GNSS 34 is used to determine a geographical location of the host vehicle 12. In an exemplary embodiment, the GNSS 34 is a global positioning system (GPS). In a non-limiting example, the GPS includes a GPS receiver antenna (not shown) and a GPS controller (not shown) in electrical communication with the GPS receiver antenna. The GPS receiver antenna receives signals from a plurality of satellites, and the GPS controller calculates the geographical location of the host vehicle 12 based on the signals received by the GPS receiver antenna.

In an exemplary embodiment, the GNSS 34 additionally includes a map. The map includes information about infrastructure such as municipality borders, roadways, railways, sidewalks, buildings, and the like. Therefore, the geographical location of the host vehicle 12 is contextualized using the map information. In a non-limiting example, the map is retrieved from a remote source using a wireless connection. In another non-limiting example, the map is stored in a database or memory of the GNSS 34.

It should be understood that various additional types of satellite-based radionavigation systems, such as, for example, the Global Positioning System (GPS), Galileo, GLONASS, and the BeiDou Navigation Satellite System (BDS) are within the scope of the present disclosure. The GNSS 34 is in electrical communication with the controller 20 as discussed above.

The vehicle communication system 36 is used by the controller 20 to communicate with other systems external to the host vehicle 12. For example, the vehicle communication system 36 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the host vehicle 12 and any remote system (e.g., vehicles, infrastructure, and/or remote systems). These messages enable communication between vehicles (V2V), vehicles and infrastructure (V2I), vehicles and pedestrians (V2P). Some examples of V2X messages include basic safety messages (BSM) (e.g., providing information about the host vehicle's position, speed, and heading to nearby vehicles), information related to key impacting traffic participants, signal phase and timing (SPaT) messages (e.g., communicating traffic signal status to vehicles, traffic light signals), traveler information messages (TIM) (e.g., sharing information about road conditions, hazards, and other relevant data), traffic patterns, onboard perception data, host vehicle route planning, a host vehicle recent speed profile, a host vehicle operator preference model, and/or personal safety messages (PSM) (e.g., used to enhance pedestrian safety by communicating their presence to nearby vehicles).

In certain embodiments, the vehicle communication system 36 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 36 may further include an embedded universal integrated circuit card (eUICC) configured to store at least one cellular connectivity configuration profile, for example, an embedded subscriber identity module (eSIM) profile.

The vehicle communication system 36 is further configured to communicate via a personal area network (e.g., BLUETOOTH), near-field communication (NFC), and/or any additional type of radiofrequency communication. However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure.

Accordingly, the vehicle communication system 36 may include one or more antennas and/or communication transceivers (not shown) for receiving and/or transmitting signals, such as cooperative sensing messages (CSMs). The vehicle communication system 36 is configured to wirelessly communicate information between the host vehicle 12 and another vehicle. Further, the vehicle communication system 36 is configured to wirelessly communicate information between the host vehicle 12 and infrastructure or other vehicles.

In another exemplary embodiment, the plurality of vehicle sensors 22 further includes sensors to determine performance data about the host vehicle 12. In a non-limiting example, the plurality of vehicle sensors 22 further includes at least one of a motor speed sensor, a motor torque sensor, an electric drive motor voltage and/or current sensor, an accelerator pedal position sensor, a brake position sensor, a coolant temperature sensor, a cooling fan speed sensor, and a transmission oil temperature sensor.

In another exemplary embodiment, the plurality of vehicle sensors 22 further includes additional sensors to determine information about an environment within the host vehicle 12. In a non-limiting example, the plurality of vehicle sensors 22 further includes at least one of a seat occupancy sensor, a cabin air temperature sensor, a cabin motion detection sensor, a cabin camera, a cabin microphone, an occupant eye tracker, and/or the like.

In another exemplary embodiment, the plurality of vehicle sensors 22 further includes additional sensors to determine information about an environment surrounding the host vehicle 12. In a non-limiting example, the plurality of vehicle sensors 22 further includes at least one of an ambient air temperature sensor, a barometric pressure sensor, and/or the like. The plurality of vehicle sensors 22 are in electrical communication with the controller 20 as discussed above.

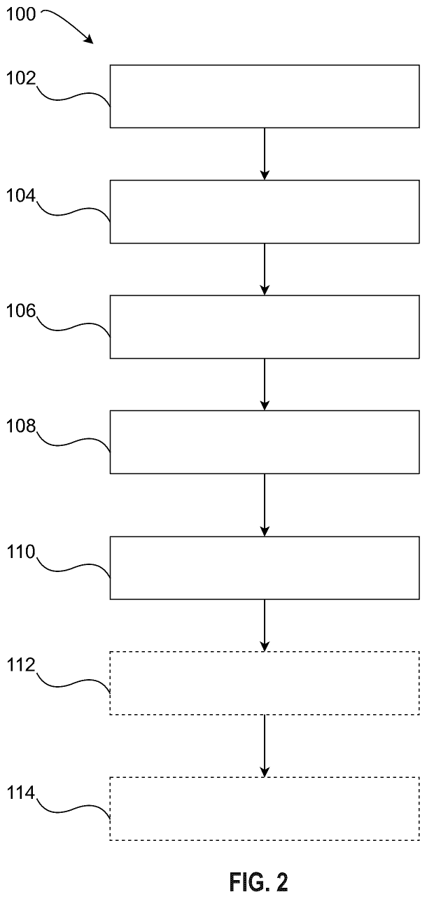

The HMI 24 is used to provide information to an occupant of the host vehicle 12. In the scope of the present disclosure, the occupant includes a driver and/or a passenger of the host vehicle 12. In the exemplary embodiment depicted in FIG. 2, the HMI 24 is a display (e.g., part of an infotainment system of the host vehicle 12) located in view of the occupant and capable of displaying text, graphics and/or images. It is to be understood that HMI display systems including LCD displays, LED displays, and the like are within the scope of the present disclosure. Further exemplary embodiments where the HMI 24 is disposed in a rearview mirror are also within the scope of the present disclosure. In an exemplary embodiment, the occupant may interact with the HMI 24 using a human-interface device (HID), including, for example, a touchscreen, an electromechanical switch, a capacitive switch, a rotary knob, a microphone for receiving voice commands, and the like. It should be understood that additional systems for displaying information to the occupant of the host vehicle 12 are also within the scope of the present disclosure. The HMI 24 is in electrical communication with the controller 20 as discussed above.

The HUD 26 is used to provide information to the occupant of the host vehicle 12. In an exemplary embodiment, the HUD 26 is configured to provide information to the occupant by projecting text, graphics, and/or images upon the windscreen 44 of the host vehicle 12. In a non-limiting example, the HUD 26 includes a projector (not shown) which is used by the controller 20 to project the text, graphics, and/or images upon the windscreen 44 of the host vehicle 12. The text, graphics, and/or images are reflected by the windscreen 44 of the host vehicle 12 and are visible to the occupant without looking away from the roadway 14 ahead of the host vehicle 12. It should be understood that various types of head-up display devices, including, for example, augmented reality head-up display (AR-HUD) devices are within the scope of the present disclosure. In an exemplary embodiment, the occupant may interact with the HUD 26 using a human-interface device (HID), including, for example, a touchscreen, an electromechanical switch, a capacitive switch, a rotary knob, a microphone for receiving voice commands, and the like. It should be understood that additional systems for displaying information to the occupant of the host vehicle 12 are also within the scope of the present disclosure. The HUD 26 is in electrical communication with the controller 20 as discussed above.

Referring to FIG. 2, a flowchart of the method 100 is shown for presenting multiple choices to a host vehicle operator to maintain smooth driving during automated or driver-assisted driving. The term “operator” may be interchangeably used with the terms “driver” or “occupant” throughout this disclosure. The method 100 begins at block 102.

Block 102 depicts receiving information at least partially based on a host vehicle environment. At block 102, the controller 20 receives the information regarding the host vehicle 12 and surrounding traffic patterns and road patterns. For example, the information may include traffic participants, traffic light signals, host vehicle route planning, a recent speed profile of the host vehicle, a driver preference model, and so forth. The driver preference model may be configured to tailor route recommendations based on individual driver preferences. A specific example may include the Driver Preference-Based Route Planning (DPRP) model, which collects data on a driver's preferences and uses the preferences to recommend optimal routes. The DPRP integrates multiple objectives and attributes, for example traffic conditions, road types, and even driver-specific preferences like avoiding toll roads or preferring scenic routes. The information may additionally include at least a host vehicle speed, host vehicle position, a host vehicle identifier (e.g., vehicle identification number (VIN), and/or other temporary identifier based on society of automotive engineers (SAE) messaging standards) or message time.

In a specific example, the controller 20 can receive V2X (Vehicle-to-Everything) messages. In an additional example, the controller 20 may receive onboard perception data from a perception sensor 32 or other sensor. In an exemplary embodiment, the perception data include a speed of the host vehicle 12 and a position measurement of each of vehicle within a one hundred foot radius. In a non-limiting example, the controller 20 uses the camera 38 to perform one or more perception measurements to obtain the perception data. In a non-limiting example, the controller 20 uses the radar sensor 40 to perform one or more perception measurements. In a non-limiting example, the controller 20 uses the LiDAR sensor 42 to perform one or more perception measurements.

In an exemplary embodiment, the one or more messages are basic safety messages (BSM) from each of the one or more surrounding vehicles including information such as, for example, a position, speed, speed history over time or a speed profile, acceleration, heading, vehicle type, vehicle identifier, vehicle dimensions, vehicle status, driver intention, message time, and/or the like. In a non-limiting example, the one or more messages are transmitted using vehicle-to-vehicle (V2V) communication techniques, such as, for example, dedicated short-range communications (DSRC). In another non-limiting example, the messages are relayed through one or more central servers (e.g., transmission over the internet or using cellular data communications). After block 102, the method 100 proceeds to block 104.

Block 104 depicts determining multiple first actions based on the information received in block 102. The controller 20 determines the multiple first actions when the host vehicle 12 is at a suitable distance to estimate a location of advantage-gaining actions. The multiple first actions include at least a first choice and a second choice. In some instances, the multiple first actions may include more than two choices (e.g., a third choice, a fourth choice, a fifth choice, and so forth). In some instances, block 102 and block 104 may be considered the preview stage. During this preview stage, the host vehicle 12 may be at an intermediate distance to estimate at least one location of an advantage-gaining action, such that the system 10 and/or the controller 20 has clearly identified action types but may not have enough confidence about their essential attributes (e.g., probability for success). In an embodiment, determining the first choice and the second choice includes determining multiple host vehicle maneuvering choices. After block 104, method 100 proceeds to block 106.

Block 106 depicts presenting the multiple first actions to the host vehicle operator. Controller 20 may present the multiple first actions using, for example, the human machine interface 24 and/or the heads-up-display 26. Presenting may also include refreshing re-determined first choice and second actions until an input is received from the host vehicle operator. It will be appreciated that the controller 20 may present the multiple first actions to the host vehicle operator using various other ways, for example via a verbal presentation using a speaker. Block 106 may be considered the interaction stage. During the interaction stage, the system 10 and/or the controller 20 has enough confidence about the essential attributes of the first choice and the second choice actions, and the first choice and second choice actions are both in the feasible spatial and/or temporal range.

In one example, the system 10 and/or controller 20 requires the driver configuration of a “challenging (but still possible advantage-gaining) action” in terms of the probability of success (e.g., in the range of 0.15-0.5, where 1 is fully successful and 0 is no success). In another example, the system 10 and/or controller 20 provides two choices of a forthcoming advantage-gaining action only if there exists some “challenging action” that is expected to yield sufficient advantage, and if such advantage is better than the expected advantage of the less challenging actions. In another example, the system 10 and/or controller 20 selects a “challenging action” having the best expected advantage (but the probability of success being no less than the driver-configured lower threshold (e.g., 0.15)) as the first choice action. In another example, the system 10 and/or controller 20 requires a driver configuration of the “comfort (but still favorable advantage-gaining) action” in terms of the probability of success (e.g., in the range 0.65-1, or at least the probability of success of the first choice action plus 0.35). In another example, the system 10 and/or controller 20 selects the “comfort action” with the best expected advantage (which may be of a different type or types compared to the one(s) of the first choice action) as the second choice action. In another example, the system 10 and/or controller 20 optimizes the comparison across different types of advantages as part of the driver preference model through a learning-based approach.

Referring to FIG. 3, an exemplary view 80 from an interior of the host vehicle 12 is shown. The exemplary view 80 includes the controller 20 presenting a first choice and a second choice in the form of exemplary HMI notification 84 displayed on the HMI 24. The exemplary HMI notification 84 includes a graphical depiction of a set of arrows representing the first choice and the second choice. In this example, the HMI 24 may provide intuitive illustrations to the driver, for example, an HMI arrowhead location to represent action location, a different color of each arrow shape that represents probability of success, and/or a differing width of arrow shape to represent an expected advantage. After block 106, the method 100 proceeds to block 108.

Block 108 depicts receiving an input from the host vehicle operator based on the multiple first actions. The host vehicle operator selects one or none of the multiple first actions, and the selection is received by the controller 20 as an input via, for example, the HMI 24. After block 108, the method 100 proceeds to block 110.

Block 110 depicts determining a second action based on the received input from the host vehicle operator. The controller 20 determines the second action. The second action may include at least one of providing no further system assistance to the host vehicle operator, providing the host vehicle operator with system assistance corresponding to the first choice, and/or providing the host vehicle operator with system assistance corresponding to the second choice. Block 108 and block 110 may be considered the finalizing stage. In this finalizing stage, at least the first choice and/or the second choice has been dismissed by the host vehicle operator and/or invalidated by the system 10 and/or the controller 20 (e.g., has passed the feasible range).

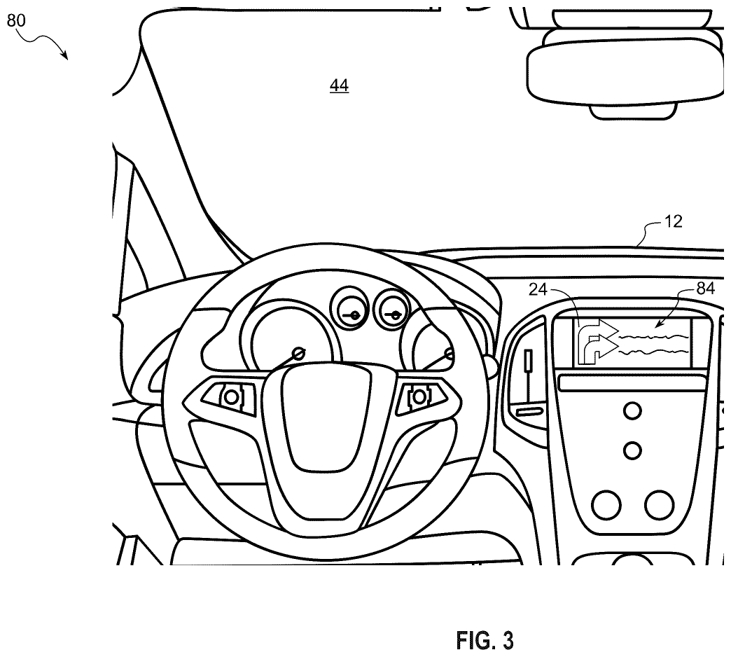

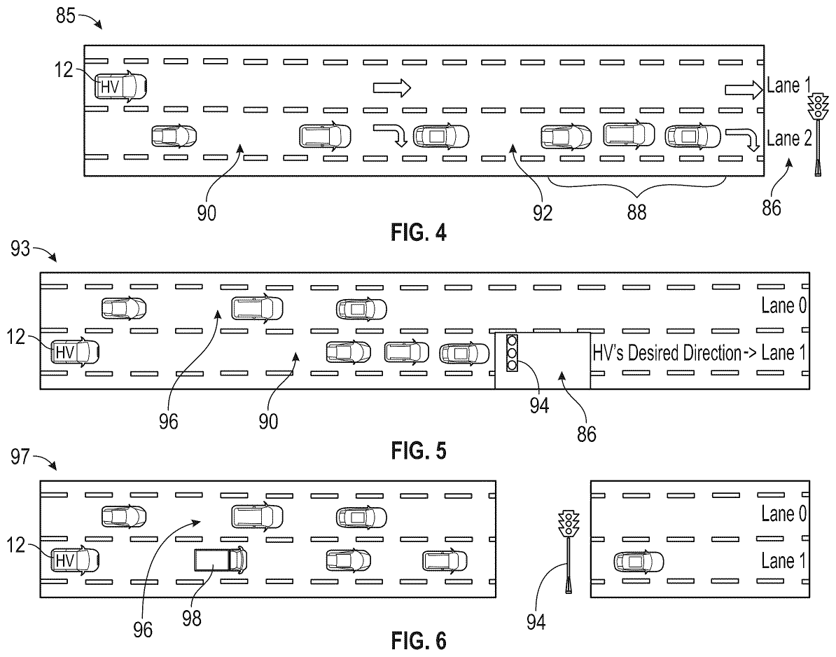

FIG. 4 illustrates a first example scenario 85 of method 100. In this scenario, lane 1 and lane 2 are illustrated with a host vehicle 12 located in lane 1. In order to follow a predetermined route, the host vehicle 12 preferably will change from lane 1 to lane 2 and then turn right at an illustrated traffic signal and intersection 86. The host vehicle 12 is located in lane 1 just left to the right-turning lane 2, and lane 2 is experiencing a queue 88 of vehicles into which the host vehicle 12 must maneuver. Based on receiving information at least partially based on a host vehicle environment (e.g., receiving V2X and/or onboard perception data, surrounding traffic patterns, host vehicle turning options) as shown at block 102, the controller 20 infers (shown at block 104) that the host vehicle 12 can choose to change lanes at a first location 90 (e.g., 50 meters before the intersection 86 for the optimal green-passing advantage, subject to a sufficient probability of success) or at a second location 92 (e.g., 100 meters before the intersection for a favorable green-passing advantage, while having significantly higher probability of success). In accordance with block 104, the two choices are assigned as a first choice and a second choice, respectively, based on driver preference and the host vehicle's 12 recent speed profile. As in block 106, the controller 20 presents, in advance, to the vehicle operator (e.g., via the HMI 24, via the HUD 26) the first choice and the second choice together with their comparisons (e.g., in the intuitive illustration of expected advantage, ease of action etc.). As in block 108 and block 110, the controller 20 and/or system 10 receives an input from the host vehicle operator and smoothly performs the input as subjectively needed toward the preferred choice (e.g., maneuvering the host vehicle 12 into the first location 90, maneuvering the host vehicle 12 into the second location 92, and/or doing nothing).

FIG. 5 illustrates a second example scenario 93 of method 100. In this scenario, lane 0 and lane 1 are illustrated with a host vehicle 12 located in lane 1. Lane 1 is controlled by a traffic light 94, and lane 0 is not controlled by the traffic light 94 (and has a more persistent free flow of traffic). However, after passing the intersection 86 or merge point ahead, the host vehicle 12 needs to be in lane 1 for routing into a desired direction. Based on receiving information at least partially based on a host vehicle environment (e.g., receiving V2X and/or onboard perception data) as shown at block 102, the controller 20 infers or determines (shown at block 104) that the host vehicle 12 and/or the host vehicle operator can be presented (at block 106) with a first choice to follow the front vehicles in the current lane (i.e., lane 1) at a first location 90 or a second choice to change lanes (i.e., to lane 0) at the nearest feasible location 96. The first choice action is advantageous if the host vehicle 12 will pass through a green light at the intersection without a full stop in lane 1, while the second choice action is of advantage otherwise (e.g., if the host vehicle 12 stops at a red light at the intersection). By providing the first choice and the second choice, the controller 20 makes the driver smoothly aware of the forthcoming advantage-gaining actions and adopts the driver's preferred choice with confident observation on the driving environment.

FIG. 6 illustrates a third example scenario 97 of method 100. In this scenario, lane 0 and lane 1 are illustrated with a host vehicle 12 located in lane 1. Lanes 1 and 0 are controlled by a traffic light 94. The host vehicle 12 is located in lane 1 with a slow-moving truck 98 in front of the host vehicle 12. The host vehicle 12 can confidently pass on green with a constant speed (e.g., about 30 kilometers per hour (kmh)) but cannot pass at a speed of 60 kmh in lane 1. The host vehicle 12 can confidently pass on green at a speed of about 60 kmh (but with a smaller time tolerance) in lane 0, and lane 0 may have a dominant impact of incoming lane changes. Based on receiving information at least partially based on a host vehicle environment (e.g., receiving V2X and/or onboard perception data) as shown at block 102, the controller 20 infers or determines (shown at block 104) that the host vehicle 12 and/or the host vehicle operator can be presented (at block 106) with a first choice to keep constant speed (e.g., about 30 kmh) in the current lane (lane 1) or a second choice to change from lane 1 to lane 0 at the nearest feasible location 96 and maintain a constant speed (e.g., about 60 kmh). The first choice action is advantageous for the host vehicle 12 if the incoming lane change from lane 1 to lane 0 is infeasible for the host vehicle 12 to pass on green with a speed of about 60 kmh, while the second choice action is of advantage otherwise. By providing the first choice and the second choice, the controller 20 makes the driver smoothly aware of the forthcoming advantage-gaining actions and adopts the driver's preferred choice with confident observation on the driving environment.

Block 112 depicts using learning-based optimization based on receiving the input from the host vehicle operator. In this step, the system 10 and/or controller 20 may use the vehicle operator's choices or lack of choices for reinforcement learning and optimization of a machine learning driver preference model. The machine learning driver preference model can be configured to receive the driver preference parameter set as an input and provide an optimal vehicle maneuvering plan as an output.

Block 114 depicts providing system assistance by driving the host vehicle based on the input from the vehicle operator. In this step, the controller 20 may use the input from the host vehicle operator to cause the host vehicle 12 to maneuver, adjust speed, or otherwise direct the host vehicle 12 to change location and position in accordance with driver preference indicated by the input.

The system 10 and method 100 of the present disclosure offer several advantages. First, the system 10 and method 100 serve to avoid surprise to the driver and facilitate driver interaction and advantage-gaining actions while ensuring the driver's satisfaction. The method 100 and system 10 are intended to provide and assist with smooth driving and/or green passing toward some intermediate distance, typically a remaining distance, until a traffic light or checkpoint ahead instead of targeting several intersections ahead or even as far as the destination. Subject to the driver's comfort and preparedness, the interaction options are designed to utilize the driver's observation of the nearby driving environment, accommodate the driver's hunch and intuition about the satisfactory advantage-gaining action, and to apply learning-based optimization on a driver preference model for improved overall satisfaction.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of presenting multiple choices to a host vehicle operator to maintain smooth driving during automated or driver assisted driving of a host vehicle, comprising:
receiving information at least partially based on a host vehicle environment;
determining multiple first actions based on the information when the host vehicle is at a distance to estimate a location of advantage-gaining actions, wherein the multiple first actions include at least a first choice and a second choice;
presenting the multiple first actions to the host vehicle operator;
receiving an input from the host vehicle operator based on the multiple first actions; and
determining a second action based on the input from the host vehicle operator, wherein the second action includes at least one of providing no further system assistance to the host vehicle operator, providing the host vehicle operator with system assistance corresponding to the first choice, or providing the host vehicle operator with system assistance corresponding to the second choice.

2. The method of claim 1, wherein the host vehicle environment includes at least one of surrounding traffic patterns or host vehicle turning options.

3. The method of claim 1, wherein the information includes at least one of V2X messages related to key impacting traffic participants, traffic light signals, traffic patterns, onboard perception data, host vehicle route planning, a host vehicle recent speed profile, or a host vehicle operator preference model.

4. The method of claim 1, wherein determining the first choice and the second choice includes determining multiple host vehicle maneuvering choices.

5. The method of claim 1, wherein determining multiple first actions includes determining a third choice.

6. The method of claim 1, wherein presenting the multiple first actions to the host vehicle operator includes presenting a first choice that gains a higher advantage than the second choice and a second choice having a higher probability of success than the first choice.

7. The method of claim 1, wherein presenting the multiple first actions to the host vehicle operator includes presenting a preview stage having suggestions to the host vehicle operator including at least one of an estimated location, an action type, a feasible spatial and temporal range, an expected challenge, or dominant impacts per-lane.

8. The method of claim 1, wherein presenting includes refreshing re-determined first choice and second choice actions until an input is received from the host vehicle operator.

9. The method of claim 1, wherein presenting the multiple first actions to the host vehicle operator includes presenting a notification of the multiple first actions to a human-machine interface (HMI).

10. The method of claim 1, wherein receiving the input includes at least one of receiving an indication that the host vehicle operator at least one of dismissed all the multiple first actions, dismissed one of the multiple first actions, switched an order of the multiple first actions, or entered no input.

11. The method of claim 1, further comprising:
using learning-based optimization based on receiving the input from the host vehicle operator.

12. The method of claim 1, further comprising:
providing system assistance by driving the host vehicle based on the input from the host vehicle operator.

13. A system for presenting multiple choices to a host vehicle operator to maintain smooth driving during automated or driver assisted driving of a host vehicle, the system comprising:
a vehicle communication system;
a display; and
a controller in electrical communication with the vehicle communication system and the display, wherein the controller is programmed to
receive information at least partially based on a host vehicle environment;
determine multiple first actions based on the information when the host vehicle is at a distance to estimate a location of advantage-gaining actions, wherein the multiple first actions include at least a first choice and a second choice;
present the multiple first actions to the host vehicle operator;
receive an input from the host vehicle operator based on the multiple first actions; and
determine a second action based on the input from the host vehicle operator, wherein the second action includes at least one of providing no further system assistance to the host vehicle operator, providing the host vehicle operator with system assistance corresponding to the first choice, or providing the host vehicle operator with system assistance corresponding to the second choice.

14. The system of claim 13, wherein the host vehicle environment includes at least one of surrounding traffic patterns or host vehicle turning options.

15. The system of claim 13, wherein the information includes at least one of V2X messages related to key impacting traffic participants, traffic light signals, traffic patterns, onboard perception data, host vehicle route planning, a host vehicle recent speed profile, or a host vehicle operator preference model.

16. The system of claim 13, wherein determining the first choice and the second choice includes determining multiple host vehicle maneuvering choices.

17. The system of claim 13, wherein presenting the multiple first actions to the host vehicle operator includes presenting a first choice that gains a higher advantage and a second choice having a higher probability of success.

18. The system of claim 13, wherein presenting includes refreshing re-determined first choice and second choice actions until an input is received from the host vehicle operator.

19. The system of claim 13, wherein receiving the input includes at least one of receiving an indication that the host vehicle operator at least one of dismissed all the multiple first actions, dismissed one of the multiple first actions, switched an order of the multiple first actions, or entered no input.

20. A method of presenting multiple choices to a host vehicle operator to maintain smooth driving during automated or driver assisted driving of a host vehicle, comprising:
receiving information at least partially based on a host vehicle environment;
determining multiple first actions based on the information when the host vehicle is at a distance to estimate a location of advantage-gaining actions, wherein the multiple first actions include at least a first choice and a second choice;
presenting the multiple first actions to the host vehicle operator;
receiving an input from the host vehicle operator based on the multiple first actions including at least one of receiving an indication that the host vehicle operator at least one of dismissed all the multiple first actions, dismissed one of the multiple first actions, switched an order of the multiple first actions, or entered no input;
determining a second action based on the input from the host vehicle operator, wherein the second action includes at least one of providing no further system assistance to the host vehicle operator, providing the host vehicle operator with system assistance corresponding to the first choice, or providing the host vehicle operator with system assistance corresponding to the second choice; and
providing system assistance by driving the host vehicle based on the input from the host vehicle operator.
